(19) United States
(12) Patent Application Publication
(10) Pub. No.: US 2015/0229723 A1
(43) Pub. Date: Aug. 13, 2015

(54) Method for Personalization and Utilization of a Series of Connected Devices

(71) Applicant: OpenForest BV, Lelystad (NL)

(72) Inventors: Michael Bosman, Lelystad (NL); Jorrit Hazelhoff, Lelystad (NL); Peter Slijkhuis, Lelystad (NL)

(73) Assignee: OpenForest BV, Lelystad (NL)

(21) Appl. No.: 14/616,781

(22) Filed: Feb. 9, 2015

Related U.S. Application Data
(60) Provisional application No. 61/937,566, filed on Feb. 9, 2014.

(51) Int. Cl. H04L 29/08; G06F 17/30; G06F 21/62

(52) U.S. Cl. CPC H04L 67/1097; G06F 21/6227; G06F 17/30864

(57) ABSTRACT

The invention is directed toward a computerized method of maintaining files for a client device comprising storing a home directory on the computer network system (the home directory is associated with a specific user), receiving a request to access the home directory from a client device, verifying the credentials of the user submitting the request, and mounting the home directory for the client device on the computer network system. In an alternative embodiment of the invention the home directory is transferred to the client device instead of being mounted on the server computer. The home directory is stored on a plurality of local servers, each of which are accessible in a specific geographic region. A user may access the home directory through any local server, improving efficiency in accessing the home folder from a remote location.

### PRIORITY

This application claims the benefit of U.S. Provisional Application No. 61/937,566, filed Feb. 9, 2014.

### FIELD OF THE INVENTION

The invention relates generally to a method of providing a computer architecture system and more specifically to a method of remotely storing and accessing a unique user-specific computer desktop.

### BACKGROUND OF THE INVENTION

Computers are prevalent in today's society. Individuals are often utilizing computers or computerized devices in any number of settings and scenarios. Individuals use computers at home for pleasure. This may include desktop computers, laptops, tablets, or any other personal computing device. Additionally, individuals use computers when working. The systems utilized at work may include desktop computers, laptops, tablets, or any other type of computing device. In addition, with the advent of web-enabled wireless cellular devices, as well as wearable computing devices, individuals are not constantly accessing or utilizing computing devices.

Each computerized device is unique. When an individual uses a specific computing device the user may change the settings on that computing device. Individuals often own multiple computing devices. If a user desires for each computing device to have identical settings, the user must manually change the settings for each individual computing device. The time required to change each device can be difficult and time consuming. Each device may have a separate and distinct user interface. An individual may be able to change the settings on one device easily but may be unable to find the means to change the settings for a separate device. What is needed is a method for a user to establish computer settings for one computing device which are then automatically transferred to all devices owned by the individual.

In addition, users treat individual computing devices differently, sometimes out of necessity. A user may save certain files locally on one specific type of computing device but not another. For instance, a user may save personal photos on a personal desktop computer which is located at the user's home. The user would not have access to those pictures on the user's work computer. If the user desired to view those personal photos on the user's work computer, the user would have to manually transfer those files by using a USB storage device or by emailing the photos to the user's email address and then downloading the photos locally to the work computer. Also, if an individual is drafting documents for work but desires to complete the project at home the user must follow the same procedure. This method can be timely and tedious and is subject to user error. The user may transfer the wrong files or forget to transfer the files altogether. What is needed is a process by a user has access to local files regardless of location and regardless of the device utilized by the user.

### SUMMARY OF INVENTION

The invention disclosed and claimed herein is sufficiently patentable and is directed toward a system and method with meaningful limitations beyond linking an abstract idea to a computer environment. As an example, and without limitation, the system disclosed and claimed improve the utilization of computer systems and an improved network interaction method. The system permits a user to interact with multiple servers across the world in an improved method. Files stored on one server are automatically transferred to a second server. When a user interfaces with the second server the user's files are already present on the second server, which decreases the time the user must wait to download those files. Therefore, the system improves the efficiency of the computer system.

In general, the system is a virtual private network, or VPN. A client is installed with a default client image and is bound to the server. A sample generic DNS name that the client attempts to connect to is localserver.local.folder. When the system first receives a DNS query from the client, this name is translated by the DNS server to the local IP address of the local server. The client is rebooted and a login box appears to the user for authentication. When the user then logs in, the authentication services of the client look for the entered username in the local copy of the LDAP database at the local server. If the correct username and password are entered into the system, the server will start the login procedure by following the instructions in the login script. One of the instructions in the login script is to mount the home directory of the user that is specified by the entered username. After the home directory is mounted, all of the user's specific settings are loaded into the system. The home folder contains all of the user's documents, pictures, wallpaper, bookmarks, etc. After all of the settings are loaded from the user's home folder, the user can start working through the client. During this process the user's home folder is locked so that the user cannot login to the network from another client computer.

After a user is done working the user logs out of the system, causing a logout script to run. All open programs are stopped and open files are closed. After logging out, the login restriction is removed and the home directory is unmounted. The local server then starts copying the user's home folder to all locations that the user's username is part of the LDAP location group. When the user travels to a new geographic location with a different local server, the user's home folder, with any updates, is already stored on that local server. The user may then log in to the new local server without needing to seek the user's home folder from the first local server, which is now geographically remote.

All of the usernames and passwords for all users are stored in the central LDAP server. All of the local servers are connected to this LDAP server. The master server sends a copy of the LDAP to each local server connected to the master server. All users' home folders are stored in the central server in the datacenter. Every local server at a specific location has its own LDAP group and only the users within that specific location group have access to the local server at that location. A user is only allowed to access the locations where the username is part of the LDAP location group. The system copies the user's home folder is only to the specified local servers where that user's username is part of the LDAP location group.

All home folders are specified within the central LDAP in a predetermined format, such as localserver.local.folder/username. In the preferred embodiment, each location has a subnet. When receiving a query, depending on the IP subnet of the location, the DNS server will check for the record for localserver.local.folder and then reply with the IP address of the local server. For instance, if a user is in Amsterdam, the IP address for localserver.local.folder/username is 111.11.11.1. However, if the user is in New York, the IP address for localserver.local.folder/username is 222.22.22.2. This permits the system to have the home folder stored in different locations but always mount the home folder with the same specifications: localserver.local.folder/username. Every LDAP account needs to have a home folder specified for each user.

The invention is directed toward a computerized method of maintaining files for a client device comprising, on a computer network, the computer network comprising a master server computer and a plurality of local server computers, the computer network system comprising a microprocessor and a nonvolatile memory unit, and the nonvolatile memory unit storing instructions which when executed by the microprocessor cause the computer network system to perform operations comprising storing a home directory on the computer network system (the home directory is associated with a specific user), receiving a request to access the home directory from a client device, verifying the credentials of the user submitting the request, and mounting the home directory for the client device on the computer network system. In an alternative embodiment of the invention the home directory is transferred to the client device instead of being mounted on the server computer.

In other embodiments of the invention, the method further comprises tracking updates made to the home directory by a user through a client device and storing the updated home directory on the computer network system. The method may further comprise transmitting the updated home directory from a first local server computer to the master server computer, storing the updated home directory on the master server computer, and transmitting the updated home directory from the master server computer to a second local server computer. The method may further comprise storing on the master server computer a list of local server computers associated with a specific user's home directory, transmitting copies of the specific user's home directory from the master server computer to the local server computers associated with the specific user's home directory, and storing copies of the specific user's home directory on the local server computers associated with the specific user's home directory.

In other embodiments the method further comprises receiving at a local server computer a query for a home directory from a client device, composing at a local server computer a TCP segment with a TCP header in response to the query, transmitting a response to the query from the local server computer to the client device, and mounting the home directory from the local server computer. The query comprises a TCP segment with a TCP header—the TCP header comprises a source port information and a destination port information, where the destination port information comprises the IP address of the primary server of the home directory. The response comprises a TCP segment with a TCP header—the TCP header comprising a source port information and a destination port information, the destination port information comprises the IP address of the client device and the source port information comprises the IP address of the primary server.

In another embodiment of the invention, the method further comprises storing a plurality of home directories on the master server computer and storing permissions associated with the plurality of home directories on the master server computer. The method may further comprise receiving instructions to modify the permissions associated with the plurality of home directories on the master server computer.

In another embodiment, the method may further comprise grouping two or more of the plurality of home directories on the master server computer based upon the respective roles of the users, receiving instructions from an administrator to establish identical permissions for the group of two or more home directories, and applying the identical permissions to each home directory in the group of two or more home directories. Furthermore, the method may further comprise storing a plurality of home directories on the master server computer.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic of a computer network utilizing the invention.

FIG. 2 is a schematic of a computer network utilizing the invention.

FIG. 3 is a schematic of a computer network utilizing the invention.

FIG. 4 is a schematic of a computer network utilizing the invention.

FIG. 5 is a schematic of a computer network utilizing the invention.

FIG. 6 is a schematic of a computer network utilizing the invention.

FIG. 7 is a schematic of a computer network utilizing the invention.

FIG. 8 is a schematic of a computer network utilizing the invention.

FIG. 9 is a schematic of a computer network utilizing the invention.

FIG. 10 is a schematic of a computer network utilizing the invention.

FIG. 11 is a schematic of a home directory.

FIG. 12a is a view of a TCP header.

FIG. 12b is a view of a TCP header.

FIG. 13 is a diagram of the method of utilizing the invention.

FIG. 14 is a diagram of the method of utilizing the invention.

FIG. 15 is a diagram of the method of utilizing the invention.

FIG. 16 is a diagram of the method of utilizing the invention.

FIG. 17 is a diagram of the method of utilizing the invention.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

The process begins with preregistering a client device with the system. The hard drive of the client device is copied and mirrored across all of the local servers. Specific software for the interface of the client device with the local servers is installed onto the client device. The client device is then configured to perform a network boot from the local server rather than from the hard drive on the client device. The client device then receives the preconfigured operating system from the local server.

The client device is at first specifically tethered to a single local server which acts as the primary server for the client device. The home directory is initially stored solely on the primary server. When the client is initially turned on the client presents a login screen to the user requesting authentication of the user's identity. In the preferred embodiment the user confirms the identity of the user by presenting a user ID and password, although other authentication methods may be used. The client then sends a query over the internet for the primary server with the user's ID and password.

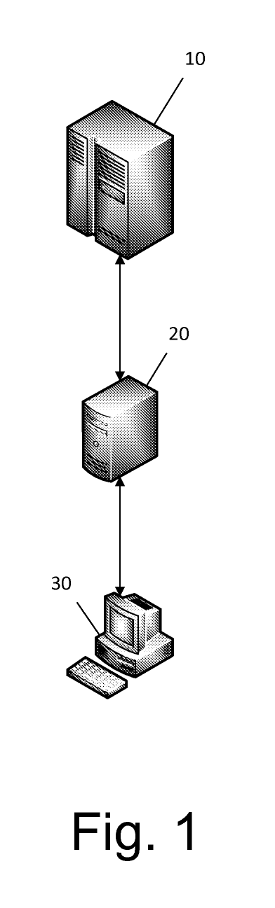

Referring to FIG. 1, the computer architecture of the system is displayed. The client device 30 is specifically tethered to a local server 20 which acts as the primary server for the client device 30. The local server 20 is communicatively connected to a master server 10. The master server 10 has total operative control over the local server 20, which acts as a slave to the master server 10. The home directory for the client device 30 is stored on the local server 20 and master server 10. Thus when a user turns on the client device 30 and enters the user's user ID and password, the client device 30 mounts the home directory from the local server 20.

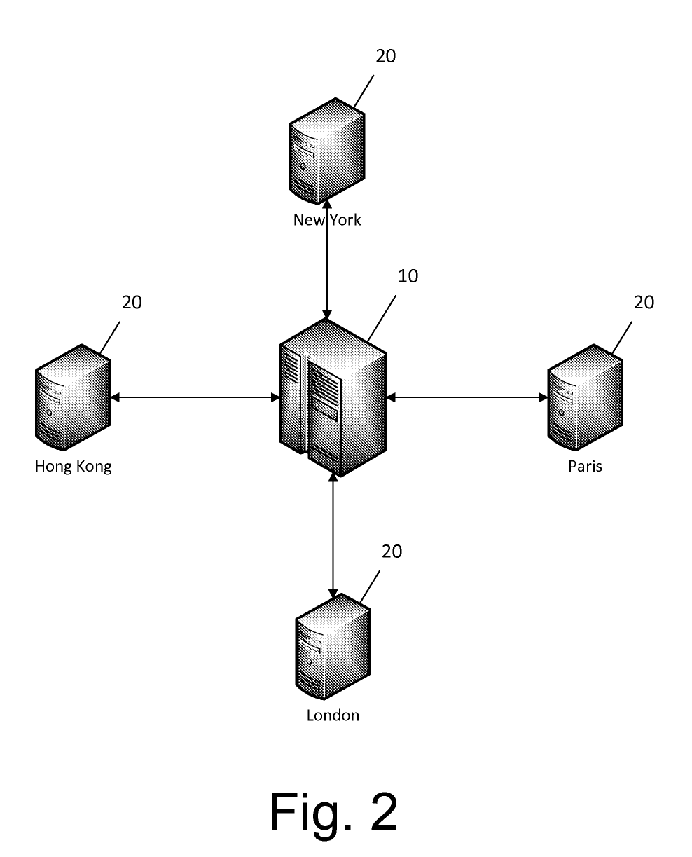

Referring to FIG. 2-5, the network structure of the system is displayed, which are presented as an illustrative example of the invention and should by no means be seen as limited the scope of the invention. The system utilizes a master server 10 which is communicatively connected to a plurality of local servers 20. Each local server 20 offers a network interface for a specific predetermined geographic area. As displayed, the master server 10 is communicatively connected to a local server 20 in London, a local server 20 in Paris, a local server 20 in New York, and a local server 20 in Hong Kong.

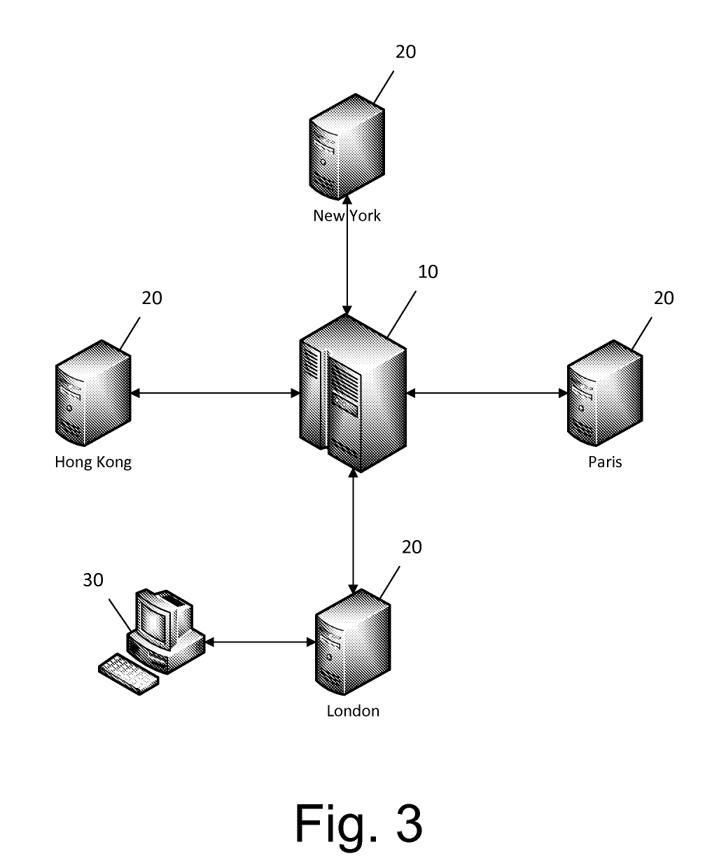

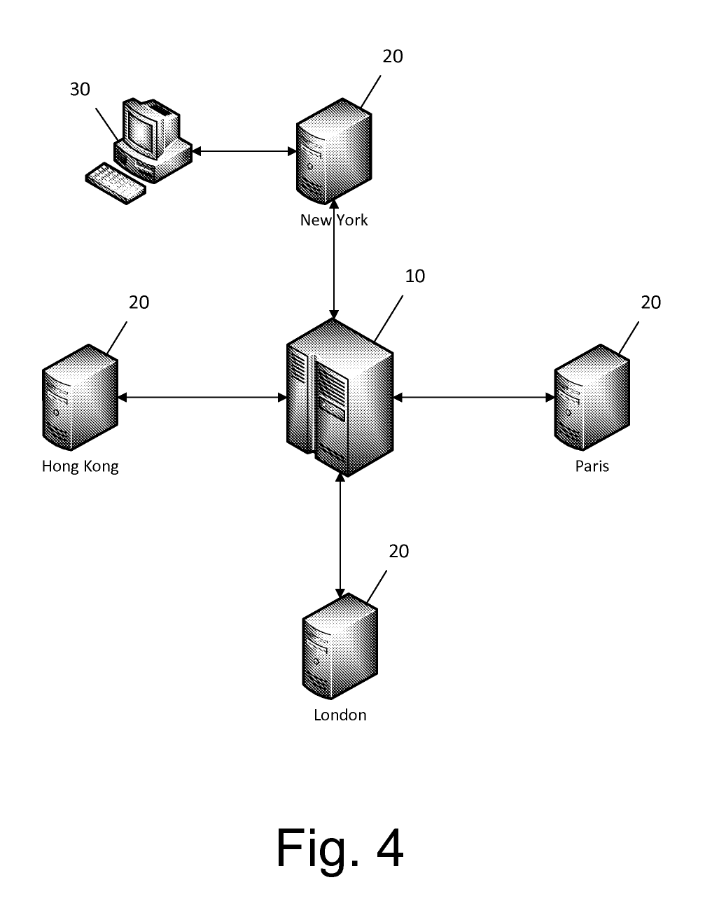

As shown in FIG. 3, a client device 30 is first connected with a local server 20 located in London. The user of the client device 30 enters the user's user ID and password and sends a query to mount the home directory to the local server in London. As displayed in FIG. 4, the user may travel to New York for business or pleasure and desire to logon to the system. At that time the client device 30 sends the query to mount the home directory to the local server 20 located in New York.

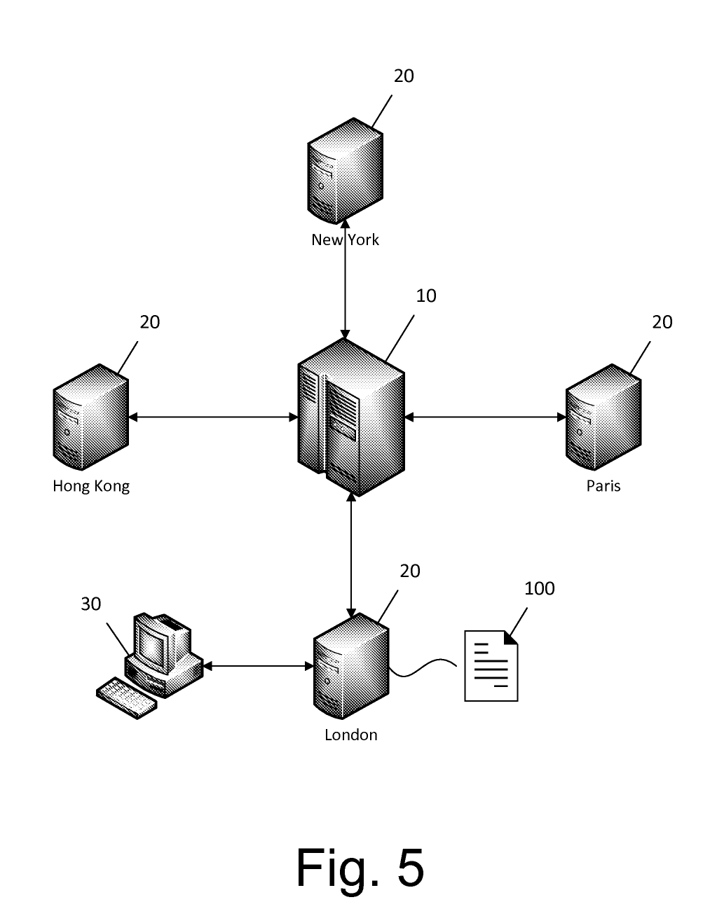

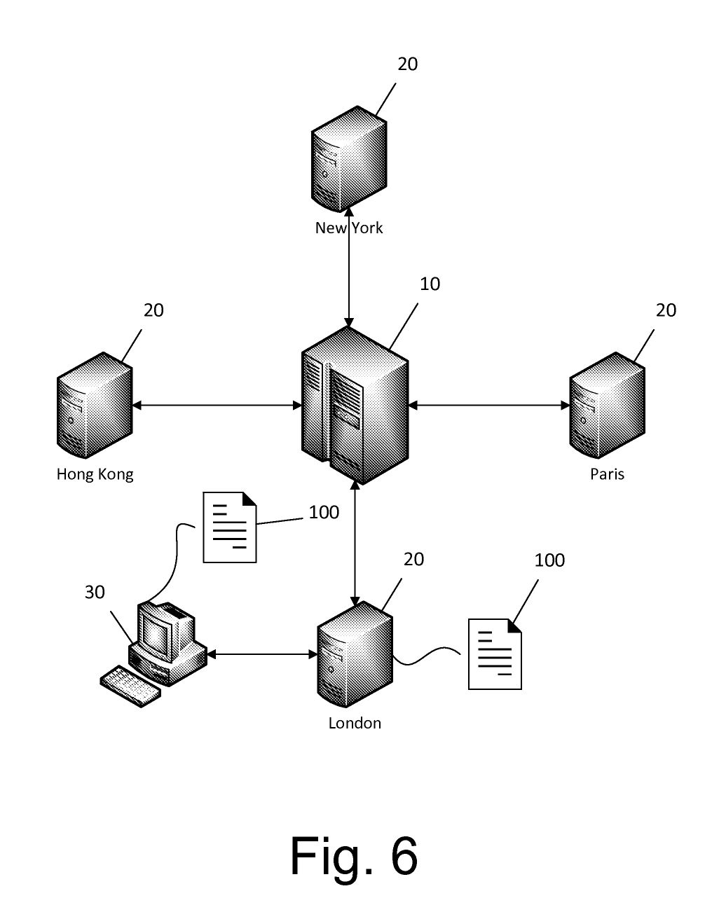

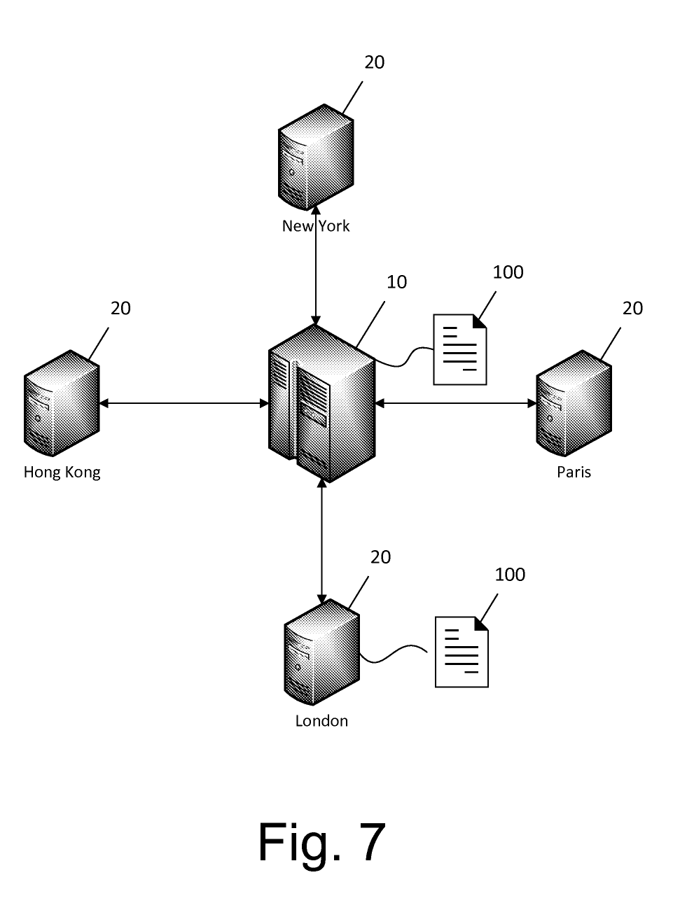

Referring to FIG. 5 and FIG. 6, when the client device 30 is turned on then the client device 30 sends a query to the local server for the home directory 100. The home directory 100 is then transferred to the client device 30 as the user requests. Thus the home directory 100 for the client device 30 is mounted by the local server 20. As the user uses the system and makes changes to the home directory 100, those changes are updated and stored on the local server 20.

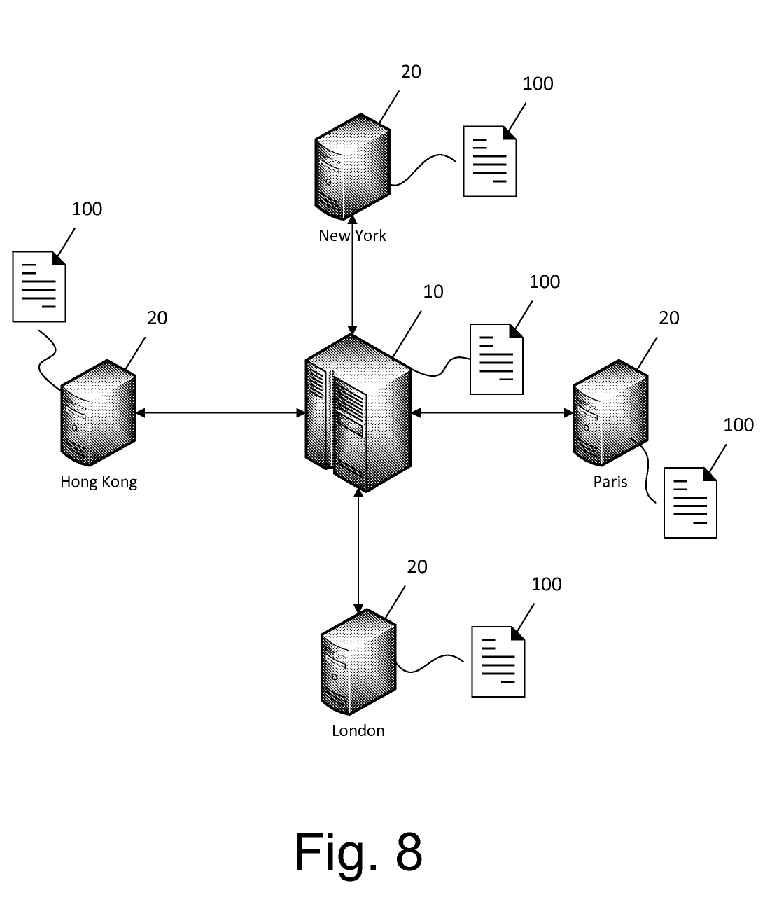

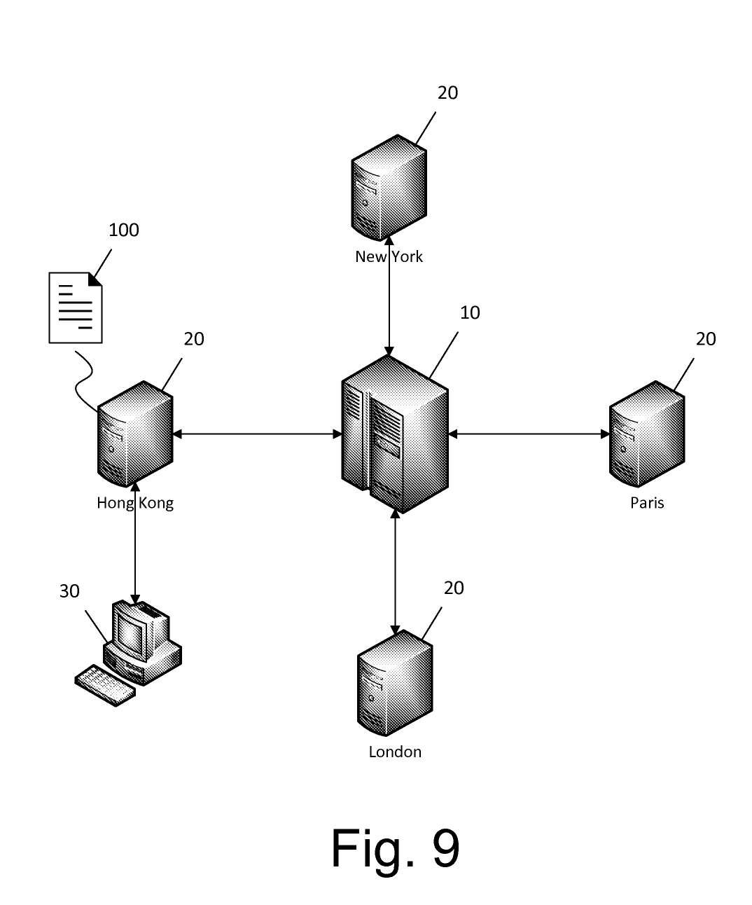

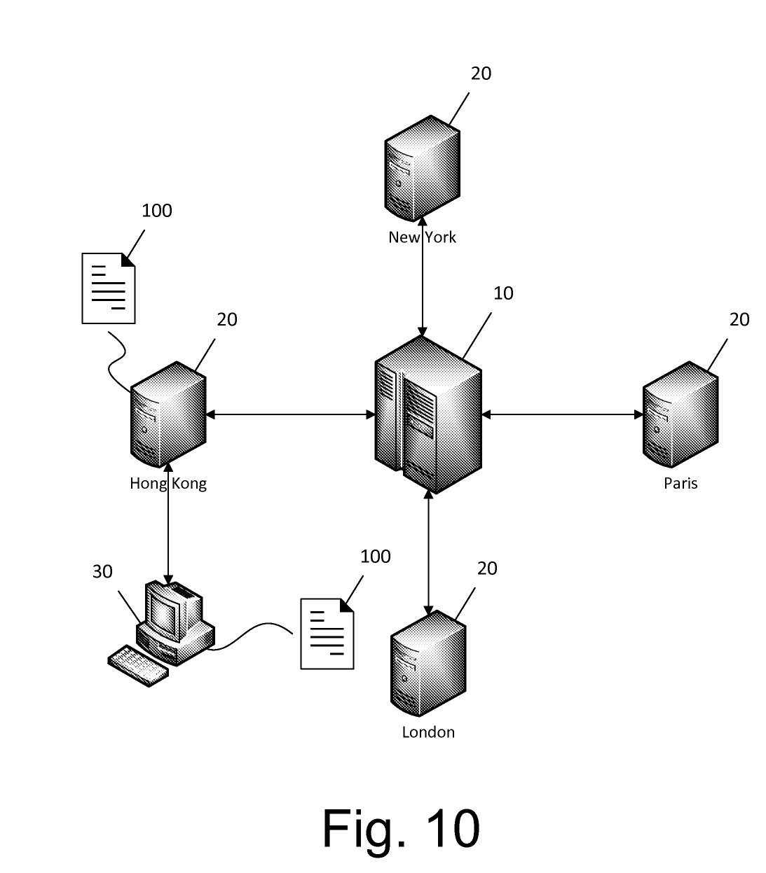

As shown in FIG. 8, when the user logs out of the system and turns off the client device 30, the client device 30 disconnects from the local server 20. The home directory 100, which has been updated by the user, is copied and transferred to the master server 10. As shown in FIG. 8, the master server 10 stores the home directory 100 on the master server 10. The master server 10 then transfers copies of the home directory to the other local servers 20 connected to the master server 10. As shown in FIG. 9, the user may then travel from London to Hong Kong and want to access the system. The user then logs on to the system using a client device 30. The client device 30 queries the local server 20 in Hong Kong for the home directory 100. After verifying the user's credentials, the local server 20 in Hong Kong mounts the home directory 100 for the client device 30, as shown in FIG. 10.

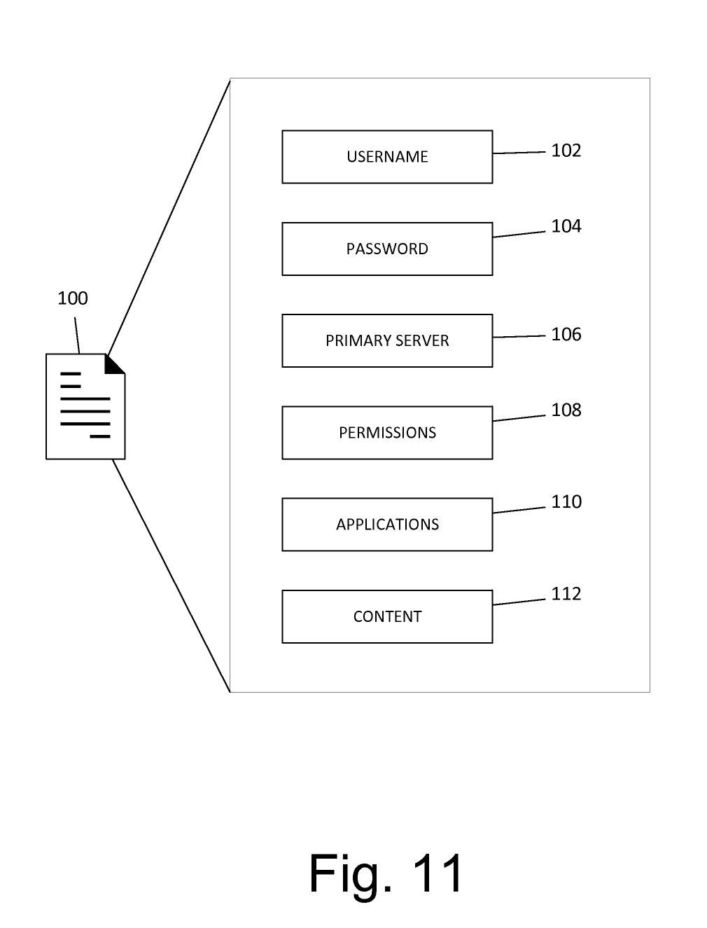

Referring to FIG. 11, the preferred embodiment of the home directory 100 is displayed. The home directory 100 contains all of a specific user's files and contents hosted on the local server 20. The home directory 100 comprises the user's username 102, the user's password 104, the IP address of the local server which acts as the primary server 106 for the user, the user's permissions 108, applications 110 available to the user, and the user's content 112. The username 102 and password 104 may be preset by an administrator for a user or may be chosen by the user. The primary server 106 is the local server which is identified as the primary host of the user's home directory 100. The permissions 108 are a group of settings which are unique to the specific user and are established by the system administrator. In the preferred embodiment, the permissions 108 include a list of those local servers 20 from which the specific user has permission to access the system. For instance, a user may have permission to access the system through the local server 20 located in New York but not the local server 20 in Hong Kong. In this example, if the user attempts to log in to the system on a client device connected to the local server 20 in Hong Kong then the user will receive a notification of a failure to access the system and the user's client device 30 will not be able to mount the home directory 100. Once the user is given permission to access the system through the local server 20 in Hong Kong then the user can log in to the system through the local server 20 in Hong Kong and the home directory 100 will be mounted to the user's client device 30. The applications 110 are those software applications which the user has the necessary licenses to utilize. In the preferred embodiment, the applications 110 are stored and executed solely on the local server 20 and the user merely uses the client device 30 as an interface to the system. In other embodiments, the applications 20 are transferred from the local server 20 to the client device 30 for execution on the client device 30. The content 112 are those files, documents, pictures, media, or other data files which are particular to the specific user. In the preferred embodiment, the content 112 is fully stored and utilized on the local server 20 and the user merely uses the client device 30 as an interface to the content 112 on the system. In other embodiments, the content 112 is transferred from the local server 20 to the client device 30 for manipulation by the user on the client device 30.

As shown in FIG. 8, the home directory 100 is transferred by the master server 10 to a plurality of local servers 20. After a client has updated files and applications in the home directory 100 from a client device 30 connected to one local server 20, all of the updates are propagated throughout the system to the master server 10 and the other local servers 20. In the preferred embodiment the updates are propagated after the user has logged off of the system. In other embodiments the updates are propagated on a continual basis while the user is logged in to the system.

The master server 10 is the main storage device for the home directory 100 and may store multiple home directories 100 of multiple users. When a user is first enrolled in the system, the administrator may establish home directory 100 to be used by the user on the master server 10. The administrator then establishes the permissions 108 for the user. In the preferred embodiment the permissions 108 are those local servers 20 from which the user may mount the home directory 100. In the preferred embodiment, the home directory 100 is only transferred and stored on those local servers 20 which are listed in the user's permissions 108. In this way, storage space and processing are utilized in an efficient manner. In other embodiments, the home directory 100 is transferred and stored on all local servers.

In the preferred embodiment, the master server 10 stores the home directories 100 of multiple users. The multiple home directories 100 are stored in an accessible database on the master server 10. In the preferred embodiment, a client device interfaces with the home directories 100 through a Lightweight Directory Access Protocol (or LDAP). An administrator can manage multiple home directories 100 by changing permissions 108 of individual users or by creating preset permissions 108 based on the role of the user. An administrator may also create groups of users who all have identical permissions 108.

Each home directory 100 has a primary server 106 associated with the specific home directory 100. The primary server 106 is the local server 20 indicated as the location of the home directory 100. When a user enters the username and password into a client device 30, the client device 30 transmits the request to mount the home directory 100 to the local server 20. Assuming that the local server 20 which the user is directly connected to is the primary server 106 the query sends a request to the primary server 106 to mount the home directory 100 from the primary server. If the local server 20 which the user is directly connected to is not the primary server 106, the query sends a request to the local server 20 to mount the home directory 100 from the primary server 106. Instead of sending the request on to the master server 10, and further on to the primary server 106, the local server 20 forges the header in the response from the local server 20 to the client device 30 to make the header appear as if the response is coming from the primary server 106.

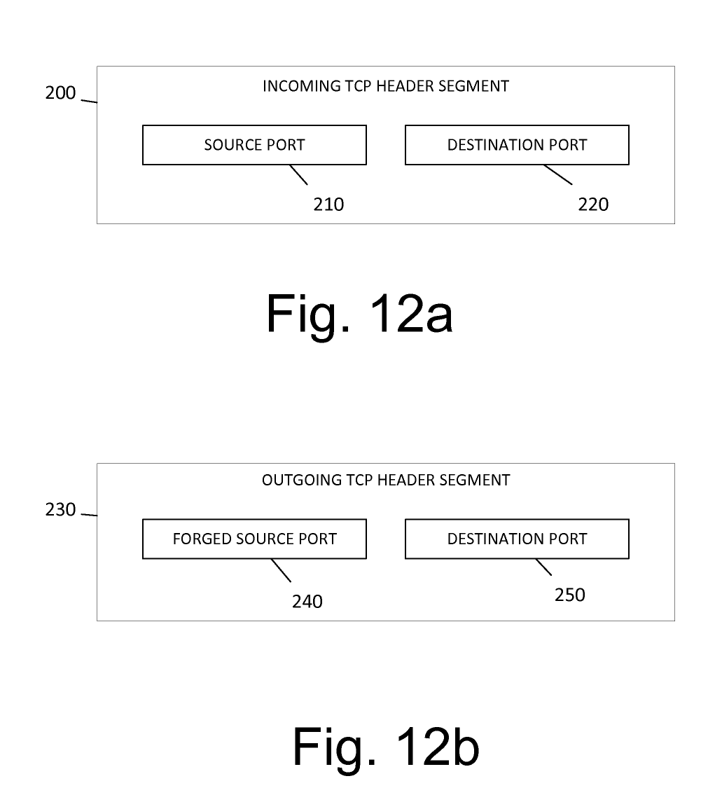

Referring to FIG. 12a and FIG. 12b, the header segments utilized in the system are displayed. As in FIG. 12a, when a user attempts to log in to the system the client device 30 creates an incoming TCP header segment 200. The incoming TCP header segment 200 is comprised of the source port 210 and the destination port 220. The source port 210 identifies the IP address of the client device 30. The destination port 220 identifies the IP address for the primary server 106. When the local server 20 receives the query from the client device 30, if the home directory 100 is stored on the local server 20, and if the local server 20 is not the primary server 106, then the local server accepts the incoming TCP header segment 200 and drafts an outgoing TCP header segment 230, which is displayed in FIG. 12b. The outgoing TCP header segment 230 is comprised of a forged source port 240 and a destination port 250. The forged source port 240 identifies the IP address of the primary server 106 although the outgoing TCP header segment 230 is sent by the local server 20. The destination port 250 identifies the IP address of the client device 30. In this manner the mounting of the home directory 100 is performed more quickly and with less transmission performed by the system.

As an illustration of this embodiment, and by no means limiting the scope of the invention, assume that a client device 30 has an IP address of 1.1.1.1. A user with the user name “JohnDoe” enters his user name and password into the client device 30. Assume that the local server 20 has an IP address of 2.2.2.2 and the home directory 100 identifies that the primary server 106 of the user has an IP address of 3.3.3.3. The local server 20 accepts the query from “JohnDoe” and verifies JohnDoe's credentials and permissions. The incoming TCP header segment 200 identifies IP address 1.1.1.1 as the source port 210 and IP address 3.3.3.3 as the destination port. Because the home directory 100 resides on the local server 20 the local server accepts the query and prepares a response. As part of the response the local server 20 drafts an outgoing TCP header segment 230. Although the outgoing TCP header segment is sent from the local server 20 with an IP address of 2.2.2.2, the local server 20 forges the source port information for the outgoing TCP header segment 230 so that it appears to be originating from the primary server 106. Thus, in this illustration, the forged source port 240 would identify the IP address of 3.3.3.3. The destination port 250 of the outgoing TCP header segment 230 identifies the IP address of the client device 30, or 1.1.1.1.

In prior art systems the location of the home directory 100 is static and only has one location. The invention thus presents an improvement over the prior art by having the location of the home directory 100 as variable and in several locations. Because of the multiple locations of the home folder 100 the system utilizes a lock file so that while the user is logged in with one client device 30, the user cannot log in with other client device 30. To log in with a secondary client device 30, the user would have to log out of the system from the first client device 30 before logging in with the second client device 30.

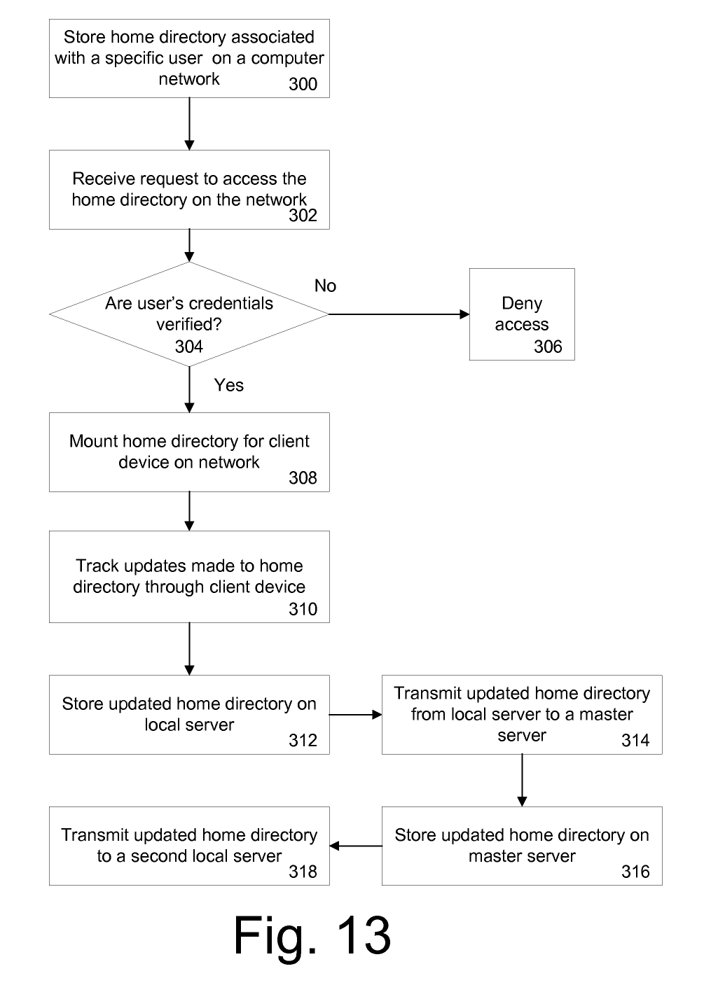

Referring to FIGS. 13-17, the method of using the invention is displayed. As shown in FIG. 13, the system stores a home directory associated with a specific user on a computer network 300. The system receives a request to access the home directory 302. The system then attempts to verify the user's credentials 304. If the user's credentials are not verified then the system denies access to the user 306. If the user's credentials are verified then the system mounts the home directory for the client device on the local server 308. The system tracks updates made to the home directory through the client device 310. The system then stores the updated home directory on the local server 312. The local server transmits the updated home directory from the local server to a master server 314. The system then stores the updated home directory on the master server 316. The system then transmits the updated home directory from the master server to a second local server which can be accessed by the user 318.

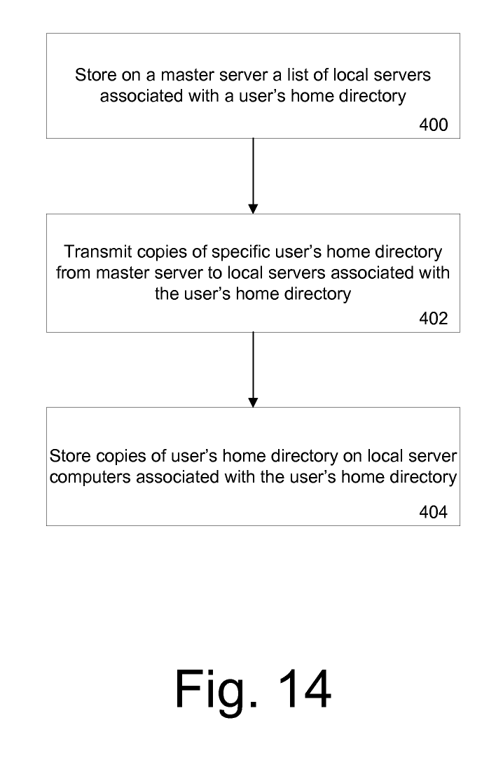

Referring to FIG. 14, the master server stores a list of the local servers that are associated with a user's home directory 400. The system transmits copies of the user's home directory from the master server to all of the local servers associated with the user's home directory 402. The system stores copies of the user's home directory on the local server computers which are associated with the user's home directory 404.

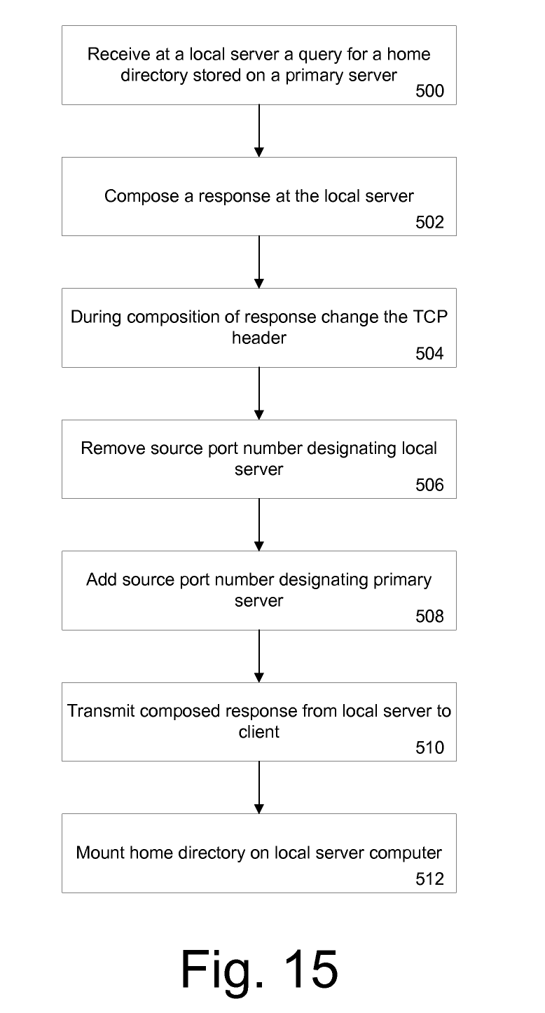

Referring to FIG. 15, the system receives, at a local server, a query for a home directory that is stored on a primary server 500. Because the user has permission to utilize the local server, the user's home directory is also stored on the local server. In response to the query the local server composes a response to the client 502. During the composition of the response the local server changes the TCP header 504. The local server removes the source port number designating the local server 506. The local server adds the source port number designating the primary server 508. The local server transmits the response to the client 510. The local server then mounts the home directory 512.

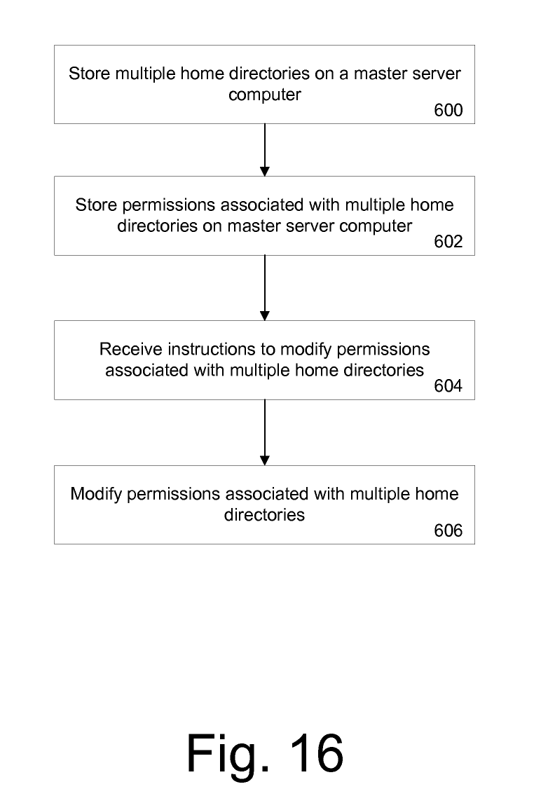

Referring to FIG. 16, the system stores multiple home directories on the master server 600. The system stores the permissions associated with the multiple home directories on the master server 602. The system can receive instructions to modify the permissions associated with the multiple home directories 604. The system then modifies the permissions associated with the multiple home directories 606.

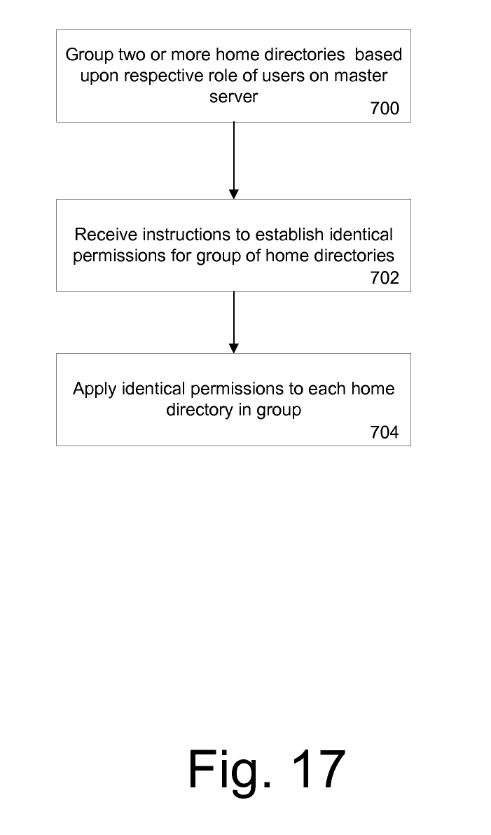

Referring to FIG. 17, the system may group two or more home directories based upon the respective roles of the users on the master server 700. The system can receive instructions to establish identical permissions for the group of home directories 702. The system then applies identical permissions to each home directory in the group 704.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A computerized method of maintaining files for a client device comprising
a. On a computer network system
i. Said computer network system comprising a master server computer and a plurality of local server computers
ii. said computer network system comprising a microprocessor and a nonvolatile memory unit
iii. said nonvolatile memory unit storing instructions which when executed by said microprocessor cause the computer network system to perform operations comprising
1. Storing a home directory on said computer network system
a. Wherein said home directory is associated with a specific user
2. Receiving a request to access said home directory from a client device
3. Verifying the credentials of the user submitting said request
4. Mounting said home directory for said client device on said computer network system.

2. The method as in claim 1 further comprising
a. Tracking updates made to said home directory by a user through a client device
b. Storing said updated home directory on said computer network system.

3. The method as in claim 2 further comprising
a. Transmitting said updated home directory from a first local server computer to said master server computer
b. Storing said updated home directory on said master server computer
c. Transmitting said updated home directory from said master server computer to a second local server computer.

4. The method as in claim 2 further comprising
a. Storing on said master server computer a list of local server computers associated with a specific user's home directory
b. Transmitting copies of said specific user's home directory from said master server computer to said local server computers associated with said specific user's home directory
c. Storing copies of said specific user's home directory on said local server computers associated with said specific user's home directory.

5. The method as in claim 3 further comprising
a. Receiving at a local server computer a query for a home directory from a client device, said query comprising a TCP segment with a TCP header
i. Said TCP header comprising a source port information and a destination port information
ii. Wherein said destination port information comprises the IP address of the primary server of said home directory
b. Composing at a local server computer a TCP segment with a TCP header in response to said query
i. Said TCP header comprising a source port information and a destination port information
ii. Wherein said destination port information comprises the IP address of said client device
iii. Wherein said source port information comprises the IP address of said primary server
c. Transmitting a response to said query from said local server computer to said client device
d. Mounting said home directory from said local server computer.

6. The method as in claim 5 further comprising
a. Storing a plurality of home directories on said master server computer
b. Storing permissions associated with said plurality of home directories on said master server computer.

7. The method as in claim 6 further comprising
a. Receiving instructions to modify the permissions associated with said plurality of home directories on said master server computer.

8. The method as in claim 6 further comprising
a. Grouping two or more of said plurality of home directories on said master server computer based upon the respective roles of the users
b. Receiving instructions from an administrator to establish identical permissions for said group of two or more home directories
c. Applying said identical permissions to each home directory in said group of two or more home directories.

9. The method as in claim 1 further comprising
a. Receiving at a local server computer a query for a home directory from a client device, said query comprising a TCP segment with a TCP header
i. Said TCP header comprising a source port information and a destination port information
ii. Wherein said destination port information comprises the IP address of the primary server of said home directory
b. Composing at a local server computer a TCP segment with a TCP header in response to said query
i. Said TCP header comprising a source port information and a destination port information
ii. Wherein said destination port information comprises the IP address of said client device
iii. Wherein said source port information comprises the IP address of said primary server
c. Transmitting a response to said query from said local server computer to said client device
d. Mounting said home directory from said local server computer.

10. The method as in claim 9 further comprising
a. Storing a plurality of home directories on said master server computer
b. Storing permissions associated with said plurality of home directories on said master server computer
c. Grouping two or more of said plurality of home directories on said master server computer based upon the respective roles of the users
d. Receiving instructions from an administrator to establish identical permissions for said group of two or more home directories
e. Applying said identical permissions to each home directory in said group of two or more home directories.

11. The method as in claim 1 further comprising
a. Storing a plurality of home directories on said master server computer
b. Storing permissions associated with said plurality of home directories on said master server computer.

12. The method as in claim 11 further comprising
a. Receiving instructions to modify the permissions associated with said plurality of home directories on said master server computer.

13. The method as in claim 11 further comprising
a. Grouping two or more of said plurality of home directories on said master server computer based upon the respective roles of the users
b. Receiving instructions from an administrator to establish identical permissions for said group of two or more home directories
c. Applying said identical permissions to each home directory in said group of two or more home directories.

14. A computerized method of maintaining files for a client device comprising
a. On a computer network system
i. Said computer network system comprising a master server computer and a plurality of local server computers
ii. said computer network system comprising a microprocessor and a nonvolatile memory unit
iii. said nonvolatile memory unit storing instructions which when executed by said microprocessor cause the computer network system to perform operations comprising
1. Storing a home directory on said computer network system
a. Wherein said home directory is associated with a specific user
2. Receiving a request to access said home directory from a client device
3. Verifying the credentials of the user submitting said request
4. Transmitting said home directory from said computer network system to said client device.

15. The method as in claim 14 further comprising
a. Tracking updates made to said home directory by a user on said client device
b. Storing said updated home directory on said computer network system.

16. The method as in claim 15 further comprising
a. Transmitting said updated home directory from said client device to a first local server computer
b. Transmitting said updated home directory from a first local server computer to said master server computer
c. Storing said updated home directory on said master server computer
d. Transmitting said updated home directory from said master server computer to a second local server computer.

17. The method as in claim 16 further comprising
a. Storing on said master server computer a list of local server computers associated with a specific user's home directory
b. Transmitting copies of said specific user's home directory from said master server computer to said local server computers associated with said specific user's home directory
c. Storing copies of said specific user's home directory on said local server computers associated with said specific user's home directory.

18. The method as in claim 16 further comprising
a. Receiving at a local server computer a query for a home directory from a client device, said query comprising a TCP segment with a TCP header
i. Said TCP header comprising a source port information and a destination port information
ii. Wherein said destination port information comprises the IP address of the primary server of said home directory
b. Composing at a local server computer a TCP segment with a TCP header in response to said query
i. Said TCP header comprising a source port information and a destination port information
ii. Wherein said destination port information comprises the IP address of said client device
iii. Wherein said source port information comprises the IP address of said primary server
c. Transmitting a response to said query from said local server computer to said client device
d. Transmitting said home directory from said local server computer to said client device.

19. The method as in claim 18 further comprising
a. Storing a plurality of home directories on said master server computer
b. Storing permissions associated with said plurality of home directories on said master server computer.

20. The method as in claim 19 further comprising
a. Grouping two or more of said plurality of home directories on said master server computer based upon the respective roles of the users
b. Receiving instructions from an administrator to establish identical permissions for said group of two or more home directories
c. Applying said identical permissions to each home directory in said group of two or more home directories.
